(19) United States
(12) Patent Application Publication
(10) Pub. No.: US 2025/0048020 A1
(43) Pub. Date: Feb. 6, 2025

(54) OWN VOICE AUDIO PROCESSING FOR HEARING LOSS

(71) Applicant: Apple Inc., Cupertino, CA (US)

(72) Inventors: Zhangli CHEN, San Jose, CA (US); Yang LU, San Jose, CA (US); Gregory N. KOSKOWICH, Pleasanton, CA (US)

(21) Appl. No.: 18/614,555

(22) Filed: Mar. 22, 2024

Related U.S. Application Data
(60) Provisional application No. 63/530,051, filed on Jul. 31, 2023.

(51) Int. Cl. H04R 1/10; G10L 17/02; H04R 3/04

(52) U.S. Cl. CPC H04R 1/1083; G10L 17/02; H04R 1/1041; H04R 3/04; H04R 2430/01

(57) ABSTRACT

Aspects of the subject technology relate to a device including a microphone and a processor. The processor receives an audio signal corresponding to the microphone. The processor detects one or more of an ambient sound or a voice of a user of the device in the received audio signal. The processor applies a first gain to the ambient sound when the ambient sound is detected in the received audio signal and apply a second gain different than the first gain to the voice of the user of the device when the voice of the user of the device is detected in the received audio signal.

### CROSS-REFERENCE TO RELATED APPLICATION(S)

This application claims the benefit of U.S. Provisional Application Ser. No. 63/530,051, entitled “OWN VOICE AUDIO PROCESSING FOR HEARING LOSS.” and filed on Jul. 31, 2023, the disclosure of which is expressly incorporated by reference herein in its entirety.

### TECHNICAL FIELD

The present description relates generally to audio processing and more particularly, but not exclusively, to own voice audio processing for hearing loss.

### BACKGROUND

Powered headphones with audio processing may analyze and optimize audio signals in real-time to create a realistic and immersive soundstage. Additionally, these headphones may integrate active noise cancellation technology, utilizing microphones to capture ambient noise and process and/or filter audio signals containing unwanted sounds.

### BRIEF DESCRIPTION OF THE DRAWINGS

Certain features of the subject technology are set forth in the appended claims. However, for purposes of explanation, several aspects of the subject technology are set forth in the following figures.

FIG. 1 illustrates a high-level block diagram of an example of own voice transmission through an air conduction pathway and a bone conduction pathway, in accordance with various aspects of the subject technology.

FIG. 2 conceptually illustrates an example environment in which an electronic device (or system) that performs own voice audio processing for hearing loss may be implemented, in accordance with various aspects of the subject technology.

FIG. 3 illustrates a high-level block diagram of an example of the electronic device with own voice audio processing, accordance with various aspects of the subject technology.

FIG. 4 illustrates a high-level block diagram of the audio processing circuitry of FIG. 2, in accordance with various aspects of the subject technology.

FIG. 5A illustrates a chart diagram of an example loudness growth function of own voice and ambient sounds for impaired hearing, in accordance with various aspects of the subject technology.

FIG. 5B illustrates a chart diagram of an example loudness compensation of own voice and ambient sounds for impaired hearing, in accordance with various aspects of the subject technology.

FIG. 6A illustrates a chart diagram of an example of dominant ambient sounds coexisting with own voice sound at frequency bins, in accordance with various aspects of the subject technology.

FIG. 6B illustrates a chart diagram of an example loud compensation to frequency bins coexisting with own voice and ambient sounds, in accordance with various aspects of the subject technology.

FIG. 7 illustrates a flow diagram of an example process of own voice audio processing, in accordance with various aspects of the subject technology.

FIG. 8 illustrates a wireless communication device within which some aspects of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block-diagram form in order to avoid obscuring the concepts of the subject technology.

A user's own voice may be transmitted and perceived differently than ambient sounds given that, for example, a user's own voice may be perceived through both a bone conduction pathway and an air conduction pathway. However, loudness compensation (or amplification) for users with impaired hearing is mainly derived from ambient sound sensing. Applying this same loudness compensation to a user's own voice may be perceived unnaturally for users with impaired hearing. The subject technology attempts to make the own voice of users with impaired hearing sound more natural. By providing a user with impaired hearing a better perception of their own voice, users with impaired hearing can, for example, achieve better control of the level of their own voice.

The subject technology can distinguish between own voice and ambient sounds (e.g., ambient noise, music, speech, etc.) using own voice activity detection. The own voice activity detection can receive sensor signals from one or more in-ear sensors (e.g., error-mic, accelerometer) and out-ear sensors (e.g., ref-mic, voice-mic). The subject technology can classify the dominant signal for one or more sub-bands or frequency bins with coexisting own voice and ambient sounds. The subject technology can apply different loudness compensation (or amplification) between the own voice and ambient sounds according to different psychoacoustic loudness growth functions. The subject technology also can attenuate the frequency bins dominated by ambient sounds when own voice and ambient sounds coexist in a frequency bin as a type of noise suppression prior to loudness compensation.

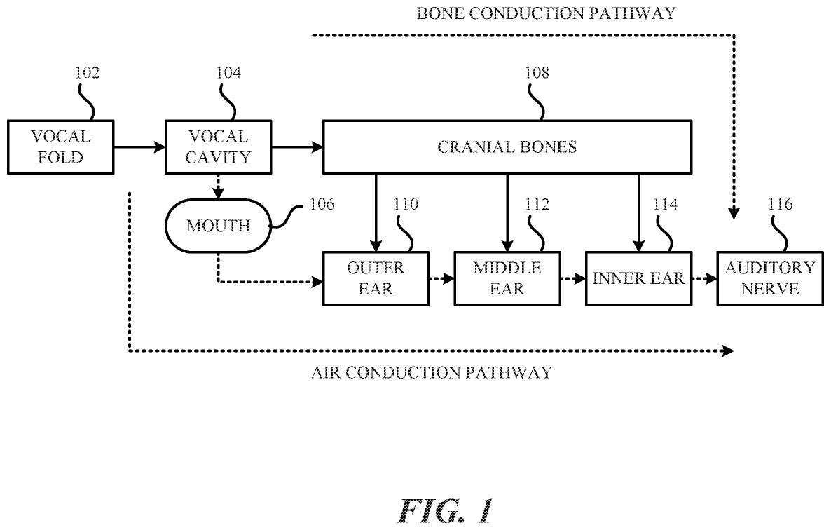

FIG. 1 illustrates a high-level block diagram of an example of own voice transmission through an air conduction pathway and a bone conduction pathway, in accordance with various aspects of the subject technology. As illustrated in FIG. 1, the physical transmission paths of the own voice sound include transmission through an air conduction pathway and a bone conduction pathway. For example, the air conduction pathway traverses vocal fold 102, vocal cavity 104, mouth 106, outer ear 110, middle ear 112, inner ear 114 and to auditory nerve 116. In another example, the bone conduction pathway traverses vocal fold 102, vocal cavity 104, cranial bones 108, outer ear 110, middle ear 112, inner ear 114 and to auditory nerve 116.

The own voice transmission through the air conduction pathway involves several anatomical structures. The process starts with the vocal folds 102, which are located in the larynx (voice box). The vocal folds 102 vibrate to produce sound waves. These sound waves then travel through the vocal cavity 104 and reach the mouth 106. From the mouth 106, the sound waves propagate through the surrounding air and enter the outer ear 110, specifically the auricle (visible part of the ear).

The sound waves then pass through the ear canal and reach the middle ear 112. In the middle ear 112, the sound waves encounter the tympanic membrane (eardrum), which vibrates in response to the sound waves. The vibration is transmitted to three tiny bones in the middle ear 112 called the ossicles: the malleus (hammer), incus (anvil), and stapes (stirrup). The ossicles amplify the vibrations and transmit them to the oval window, a membrane-covered opening that leads to the inner ear 114.

Once the sound waves reach the inner ear 114, they stimulate the fluid-filled cochlea, a spiral-shaped structure. The movement of the fluid in the cochlea causes the hair cells lining its walls to bend, generating electrical signals. These electrical signals are then picked up by the auditory nerve 116, which connects the cochlea to the brain. The auditory nerve 116 earries the signals to the brain's auditory cortex, where they are interpreted as sound.

Similar to the air conduction pathway, the bone conduction pathway also involves the vocal folds 102 and the vocal cavity 104. However, instead of the sound waves traveling through the air, they are conducted through the bones of the skull. The vibrations generated by the vocal folds 102 and the resonance in the vocal cavity 104 are directly transmitted to the cranial bones 108.

From the cranial bones 108, the vibrations are transmitted to the outer ear 110, specifically the auricle, which collects the vibrations. The vibrations then travel through the ear canal and reach the middle ear 112, where they cause the tympanic membrane and ossicles to vibrate in a similar manner as in the air conduction pathway. The ossicles amplify the vibrations, which are then transmitted to the oval window.

Once the vibrations reach the inner ear 114, they continue to stimulate the cochlea in the same way as in the air conduction pathway. The fluid in the cochlea moves, bending the hair cells and generating electrical signals. These signals are picked up by the auditory nerve 116 and transmitted to the brain for interpretation.

In one or more implementations, own voice sound is transmitted and perceived differently from ambient sounds. For example, the physical transmission path of ambient sounds includes transmission at least partially through the air conduction pathway and not through the bone conduction pathway. An ambient sound from a sound source in the surrounding environment can be received at the outer ear 110 and continues along the air conduction pathway with propagation of sound waves through the middle ear 112, inner ear 114 and stimulation of the auditory nerve 116, ultimately reaching the brain for sound perception.

In the field of hearing loss compensation, the amplification of ambient sounds receives the primary focus due to several reasons. Firstly, the technical challenges associated with reliably detecting one's own voice make it difficult to distinguish between the microphone's captured signal as either the user's own voice or ambient sounds. This challenge is exacerbated by the lack of in-ear sensors, such as accelerometers, in most traditional hearing aids. The absence of these sensors hinders the development of reliable algorithms for differentiating between the user's voice and ambient sounds.

Secondly, while international and US standards (e.g., ISO532; ANSI S3.4) provide loudness models for ambient sounds, including extensions for impaired hearing, no readily available loudness growth functions exist for the user's own voice, whether in cases of normal or impaired hearing. Consequently, hearing aid manufacturers lack guidance on setting appropriate gain levels to restore the loudness of the user's own voice to a normal range. For example, when the ear canal is blocked by an earphone, there is an occlusion effect that boosts the sound frequencies below 1 kHz by as large as 30 dB and causes a lack of clarity in the own voice. In another example, earphones with feedback active noise cancellation (FBANC) can attenuate the occlusion effect by up to around 20 dB, in which 20 dB is the approximate limitation for the stability of FBANC. In another example, hearing aids without FBANC may traditionally use earmolds with a vent or ear tips with holes to unblock the ear canal and mitigate the occlusion effect.

Furthermore, empirical evidence contradicts the notion that hearing aid users will acclimate to their amplified own voice. In reality, users often express dissatisfaction with the unnatural perception of their own voice. This unnatural perception, in turn, affects the user's ability to control their own voice level during conversations. For instance, if the amplification is set too high for the user's own voice, they may need to alter their pronunciation, resulting in reduced audibility for the listener. Conversely, speaking at a normal level for the listener results in the user perceiving their own voice as excessively loud due to the high amplification of the hearing aids.

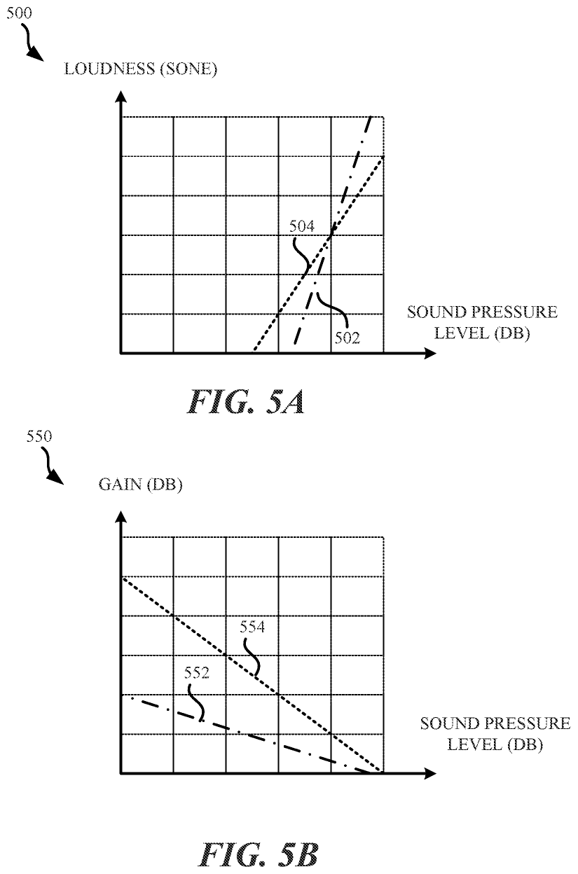

The above reasons highlight the predominant emphasis on amplifying all sounds including both ambient sounds and own voice at the same level in hearing loss compensation as opposed to applying a different gain for ambient sounds and the user's own voice, as challenges related to detecting one's own voice, lack of in-ear sensors, and absence of reliable algorithms hinder effective compensation for the user's voice. Because the user's own voice is perceived differently than ambient sounds due to the physical transmission paths between the ambient sounds and own voice being different, amplifying all sounds to the same level using loudness compensation traditionally derived from ambient sound sensing causes the unnatural perception of the user's own voice. Addressing these limitations may facilitate developing improved hearing aid systems that provide accurate and natural amplification for the user's own voice. The effects of the two conduction paths will be described in more detail in FIGS. 5A-B below.

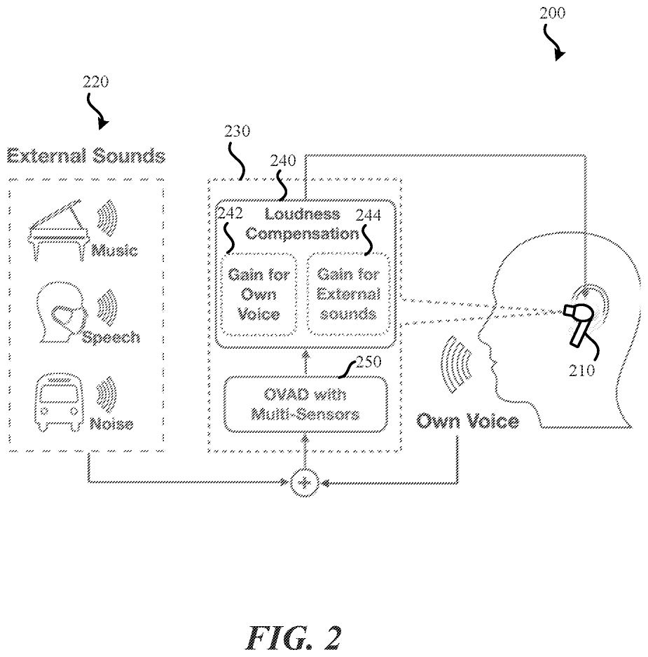

FIG. 2 conceptually illustrates an example environment 200 in which an electronic device (or system) that performs own voice audio processing for hearing loss may be implemented, in accordance with various aspects of the subject technology. The environment 200 includes electronic device 210 and ambient sounds 220. In one or more implementations, the ambient sounds 220 represent various audio signals that may be present in the environment 200, including speech, noise, and other acoustic stimuli.

The electronic device 210 includes audio processing circuitry 230. The electronic device 210 acts as the platform for implementing the audio processing circuitry 230 and delivering the optimized audio signals to the user. It may include hardware and software circuitry to perform real-time processing, including signal acquisition, processing algorithms, and audio output capabilities. In some implementations, some of the functionalities of the audio processing circuitry 230 can be performed by a processor of a host device, such as a smartphone or a smartwatch. In one or more implementations, the electronic device 210 can be a headset, a headphone, an earbud or an audio output device that is coupled, wirelessly or via a wired link, to a handheld device, such as a smartphone, a smartwatch or a tablet, or to a computing device such as a laptop or desktop computer.

The audio processing circuitry 230 facilitates enhancing the user's perception of their own voice and ambient sounds. It includes two primary elements: the loudness compensation circuitry 240 and the own voice activity detector (OVAD) with multi-sensors 250.

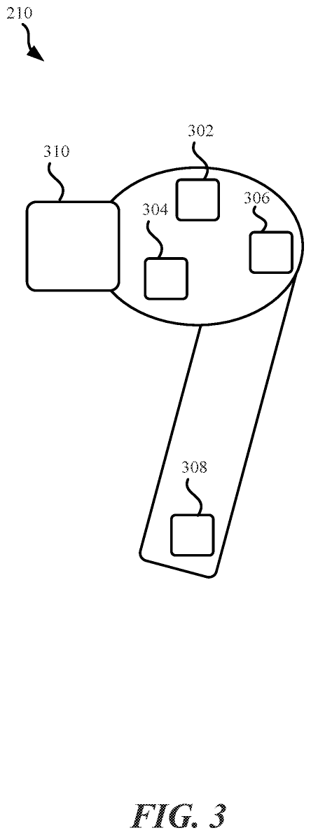

The loudness compensation circuitry 240 includes own voice gain circuitry 242 and ambient sound gain circuitry 244. The own voice gain circuitry 242 performs operations pertaining to amplifying and adjusting the user's own voice signals, which will be described in more detail below with reference to FIGS. 3-7. The own voice gain circuitry 242 may take into account the individual user's specific hearing loss characteristics and facilitates that the amplified own voice is perceived clearly and comfortably.

The ambient sound gain circuitry 244 adjusts the amplification levels of ambient sounds captured by the electronic device 210. The ambient sound gain circuitry 244 may employ algorithms and signal processing techniques to enhance audibility and optimize the clarity of environmental sounds.

The own voice activity detector (OVAD) with multi-sensors 250 facilitates accurately identifying the user's own voice activity. The OVAD with multi-sensors 250 may integrate multiple different sensors, such as in-ear and out-ear sensors, to capture and/or analyze audio signals. The multi-sensor approach helps distinguish the user's voice from other ambient sounds and provides contextual information for precise processing and adjustment.

FIG. 3 illustrates a high-level block diagram of an example of the electronic device 210 with own voice audio processing, accordance with various aspects of the subject technology. The electronic device 210 incorporates multiple sensors to enhance its functionality and improve the user's listening experience. The electronic device 210 may consist of in-ear sensors and out-ear sensors, each serving a specific purpose. In one or more implementations, the in-ear sensors and out-ear sensors are, or include at least part of, the OVAD with multi-sensors 250 as described with reference to FIG. 2. The in-ear sensors include an error-microphone 304 and an accelerometer 302, while the out-ear sensors consist of a reference-microphone 306 and a voice-microphone 308. In one or more implementations, the electronic device 210 includes a speaker 310.

The error-microphone 304, located within the ear canal, captures the sound signal generated by the speaker 310 of the electronic device 210. The error-microphone 304 provides feedback on the output sound, allowing the electronic device 210 to adjust its settings and facilitate accurate sound reproduction. The accelerometer 302, also positioned in the ear, measures motion and vibrations, providing contextual information about the user's movement and activity, such as the movement of the user's mouth when speaking.

The out-ear sensors, including the reference-microphone 306 and voice-microphone 308, are placed outside the ear. The reference-microphone 306 picks up ambient sounds and background noise in the environment, while the voice-microphone 308 is specifically directed to capturing the user's own voice.

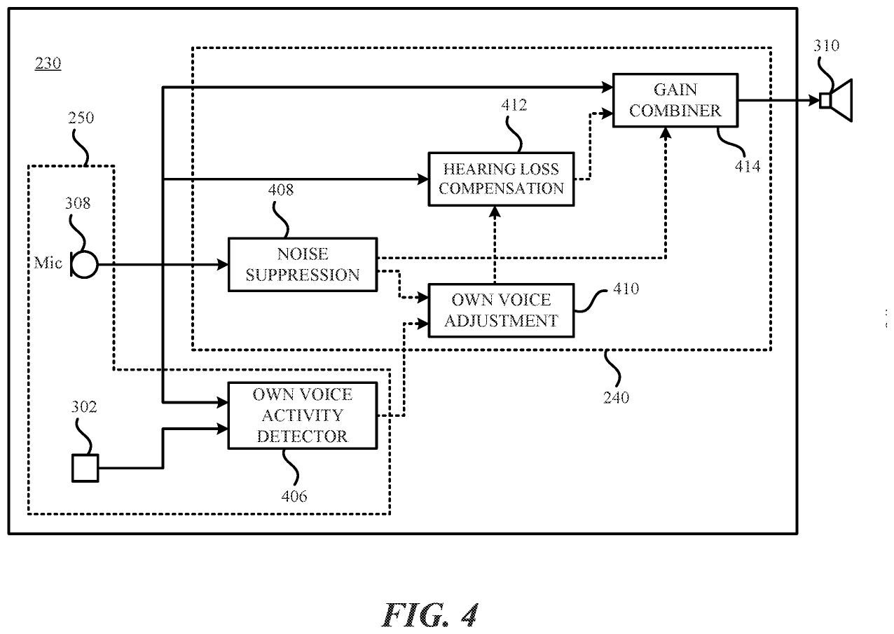

The own voice activity detector (e.g., 406 of FIG. 4) facilitates distinguishing the user's own voice sound from ambient sounds, which will be described in more detail with reference to FIG. 4. It combines the signals from one or more of the sensors to achieve this task. The error-microphone 304, accelerometer 302, reference-microphone 306, and/or voice-microphone 308 inputs are analyzed collectively to determine the presence of the user's voice.

The error-microphone 304 and accelerometer 302 signals provide information about the generated sound and the user's movement patterns, respectively. By comparing these signals to the reference-microphone 306 and voice-microphone 308 inputs, the own voice activity detector can differentiate between the user's voice and ambient sounds.

The reference-microphone 306 captures the ambient noise, which helps identify and suppress unwanted sounds from the user's own voice. Additionally, the voice-microphone 308 is specifically directed to capturing the user's voice, serving as a primary source for detecting the presence of own voice activity.

Using advanced algorithms and signal processing techniques, the own voice activity detector analyzes and combines the inputs from all the sensors. It applies pattern recognition, frequency analysis, and/or other algorithms to distinguish the unique characteristics of the user's own voice from ambient sounds. For example, the own voice activity detector may execute an OVAD algorithm. In one or more implementations, the OVAD algorithm can combine one or more of the sensor signals to distinguish between the user's own voice and ambient sounds. In one or more implementations, the input signals can be classified by the OVAD algorithm into the following types of classifications: a classification indicating that the input signals include only the own voice, a classification indicating that the input signals include only the ambient sounds, and a classification indicating that the input signals include a combination of the own voice and the ambient sounds.

By accurately detecting own voice activity, the electronic device 210 can optimize processing and amplification settings specifically directed to the user's voice. This enables improved audibility and clarity, minimizing the interference of ambient sounds and maximizing the user's ability to perceive and understand their own speech.

FIG. 4 illustrates a high-level block diagram of another example of the audio processing circuitry 230 of FIG. 2, in accordance with various aspects of the subject technology. The audio processing circuitry 230 includes the loudness compensation circuitry 240 and the OVAD with multi-sensors 250. The OVAD with multi-sensors 250 includes the microphone 308, the accelerometer 302, and an own voice activity detector 406. The loudness compensation circuitry 240 includes a noise suppression circuitry 408, an own voice adjustment circuitry 410, a hearing loss compensation circuitry 412, and a gain combiner 414. The audio processing circuitry 230 is also coupled to the speaker 310.

The own voice audio processing system includes several circuits designed to enhance the quality and intelligibility of the user's own voice. The own voice audio processing system includes the microphone 308 that captures the user's voice and the accelerometer 302 that measures motion and vibrations.

The microphone 308 signal is split and sent to two processing circuits: the noise suppression circuitry 408 and the own voice activity detector 406. In one or more implementations, the microphone 308 may include at least a portion of the reference-microphone 306. In one or more other implementations, the audio processing circuitry 230 includes the reference-microphone 306 separate from the microphone 308 and coupled to one or more of the own voice activity detector 406, the noise suppression circuitry 408, the hearing loss compensation circuitry 412 or the gain combiner 414.

The noise suppression circuitry 408 aims to reduce background noise and other unwanted sounds from the microphone 308 input. Simultaneously, the own voice activity detector 406 analyzes the audio signal to detect and distinguish the user's own voice activity.

The accelerometer 302 data is also fed into the own voice activity detector 406, providing additional contextual information that helps in accurately identifying the user's own voice. By incorporating motion and vibration data, the own voice audio processing system can better differentiate between the user's voice and other ambient sounds.

The own voice activity detector 406 can accurately detect and determine the occurrence of the user's own voice. This is achieved through the calculation of metrics such as magnitude-squared coherence, normalized cross-correlation, and/or other suitable metrics.

Magnitude-squared coherence is a metric used to quantify the similarity or coherence between two signals. In the context of the own voice activity detector 406, it measures the similarity between the captured audio signal and a reference signal that represents the user's own voice. By analyzing the magnitude-squared coherence, the own voice activity detector 406 can identify whether the captured signal corresponds to the user's own voice activity.

Normalized cross-correlation is another metric that may be used in the own voice activity detector 406. It measures the similarity between two signals by calculating the correlation between them. In this case, the own voice activity detector 406 computes the normalized cross-correlation between the captured audio signal and a reference signal that represents the user's own voice. By analyzing the resulting values, the own voice activity detector 406 determines whether the captured signal contains the user's own voice.

These metrics are calculated within the own voice activity detector 406 using signal processing techniques. The own voice activity detector 406 can continuously process the audio input, capturing and analyzing the characteristics of the signal in real-time. By comparing the calculated metrics with predefined thresholds, the own voice activity detector 406 can classify whether the audio input corresponds to the user's own voice or other ambient sounds.

The use of metrics such as magnitude-squared coherence or normalized cross-correlation provides a reliable means of determining the occurrence of the user's own voice. These calculations enable the own voice activity detector 406 to make accurate and informed decisions in audio processing systems, facilitating the appropriate handling of the user's own voice for optimal performance and user experience.

The noise suppression circuitry 408 is an integral part of the own voice audio processing system that aims to reduce the presence of background noise in speech signals. In one or more implementations, the noise suppression circuitry 408 is implemented at least partially by hardware, firmware, and/or software. One aspect of its operation involves estimating a bin-by-bin suppression gain for the speech signal. The bin-by-bin suppression gain estimation is based on analyzing the spectral characteristics of the speech signal in each frequency bin. The circuitry performs a spectral analysis of the incoming speech signal, dividing it into individual frequency bins.

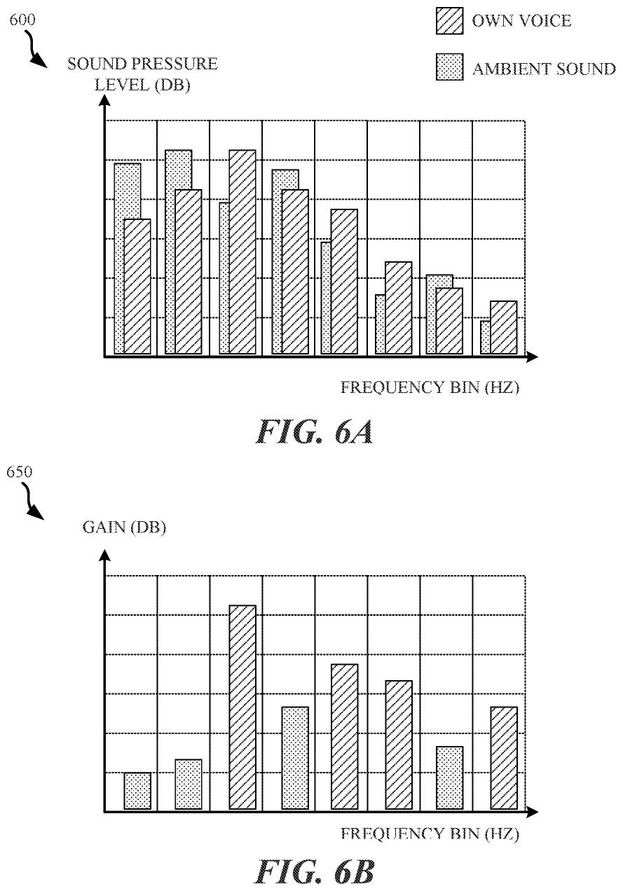

For each frequency bin, the own voice adjustment circuitry 410 calculates a suppression gain value. This gain value represents the amount by which the ambient sounds in that particular frequency bin should be attenuated, which is illustrated with reference to FIG. 6B. The gain estimation takes into account the power or magnitude of the ambient sounds in relation to the desired own voice signal.

To determine the suppression gain, the own voice adjustment circuitry 410 can rely on statistical analysis and adaptive algorithms. It utilizes techniques such as spectral subtraction, Wiener filtering, and/or other advanced algorithms that consider both the properties of the ambient sounds and the characteristics of the desired own voice signal.

The estimation of the bin-by-bin suppression gains in the noise suppression circuitry 408 may facilitate achieving noise reduction while preserving the integrity and naturalness of the speech signal. By adaptively adjusting the suppression gains in real-time, the noise suppression circuitry 408 facilitates optimal noise suppression performance across different acoustic environments and noise types.

The output from the noise suppression circuitry 408 is then sent to the own voice adjustment circuitry 410. The own voice adjustment circuitry 410 processes the microphone 308 signal based on the detected own voice activity from the own voice activity detector 406 to refine and optimize the user's voice representation. It adjusts parameters such as frequency response, gain, or dynamic range to improve the overall clarity and quality of the own voice signal.

The own voice adjustment circuitry 410 plays a critical role in audio processing systems by fine-tuning the representation of the user's own voice. It achieves this by combining the output of the own voice activity detector 406 with the output of the noise suppression circuitry 408 to estimate a bin-by-bin own voice presence probability (OVPP). In one or more implementations, the OVPP indicates a likelihood that own voice is present in a frequency bin.

In one or more implementations, the own voice adjustment circuitry 410 can determine a dominant signal between the ambient sound and the voice of the user of the electronic device 210 for one or more frequency bins associated with the received audio signal based on at least partial overlap of the ambient sound with the voice of the user of the electronic device 210 in frequency.

The OVPP value, generated through the own voice adjustment circuitry 410, facilitates determining the dominant signal between the user's own voice and ambient sounds within a given frequency bin. This information is employed by the hearing loss compensation circuitry 412 to accurately differentiate and prioritize the relevant signals. When processing audio signals, the hearing loss compensation circuitry 412 analyzes the OVPP values on a bin-by-bin basis. Each frequency bin is evaluated to assess the likelihood of the user's own voice being present compared to ambient sounds.

Based on the OVPP value for a specific frequency bin, the own voice adjustment circuitry 410 determines the dominant signal. If the OVPP value indicates a higher probability of the user's own voice, the own voice adjustment circuitry 410 recognizes the own voice as the dominant signal within that bin. Conversely, if the OVPP value suggests a lower probability of the user's own voice, the own voice adjustment circuitry 410 identifies ambient sounds as the dominant signal.

By making this distinction, the own voice adjustment circuitry 410 can adapt its processing techniques accordingly. When the user's own voice is identified as the dominant signal, the own voice adjustment circuitry 410 facilitates that the own voice is preserved and appropriately amplified to maintain audibility and intelligibility. In contrast, when ambient sounds are identified as the dominant signal, the own voice adjustment circuitry 410 focuses on suppressing or reducing the amplification of those sounds to enhance speech clarity and reduce background noise interference.

By applying the estimated bin-by-bin suppression gains to the speech signal, the noise suppression circuitry 408 selectively reduces the amplitude or power of the noise in each frequency bin that has the dominant signal characterized as the ambient sounds. In one or more implementations, the noise suppression circuitry 408 can refrain from attenuating the speech signal in a corresponding frequency bin when the dominant signal is characterized as own voice. This process helps enhance the clarity and intelligibility of the speech signal by minimizing the interference caused by background noise.

The own voice activity detector 406 provides information about the occurrence of the user's own voice within the audio input. It analyzes the characteristics of the signal to identify and classify segments that contain the user's own voice. The output of the own voice activity detector 406 represents the presence or absence of the user's own voice at different time intervals. In one or more implementations, the own voice activity detector 406 is implemented at least partially by hardware, firmware, or software. In some implementations, some of the functionalities of the own voice activity detector 406 can be performed by a processor of a host device, such as a smartphone or a smartwatch.

The noise suppression circuitry 408, on the other hand, focuses on reducing the impact of background noise in the audio signal. It selectively attenuates the noise to enhance the intelligibility and clarity of the desired speech signal. For example, the noise suppression circuitry 408 selectively attenuates the gain of the speech signal when the dominant signal is characterized as the ambient sounds. The output of the noise suppression circuitry 408 represents the processed speech signal with reduced noise.

The own voice adjustment circuitry 410 combines the outputs of the own voice activity detector 406 and the noise suppression circuitry 408 to estimate the bin-by-bin OVPP. It analyzes the presence or absence of information provided by the own voice activity detector and the noise-suppressed speech signal. In one or more implementations, the own voice adjustment circuitry 410 is implemented at least partially by hardware, firmware, or software. In some implementations, some of the functionalities of the own voice adjustment circuitry 410 can be performed by a processor of a host device, such as a smartphone or a smartwatch.

By examining the time intervals where the own voice is detected and comparing it with the noise-suppressed speech signal, the own voice adjustment circuitry assigns a probability value to each frequency bin. This probability represents the likelihood of the user's own voice being present in that specific bin.

The estimation of the bin-by-bin own voice presence probability enables precise control and adjustment of the user's own voice in the final audio output. It allows for selective modification of the user's voice representation, ensuring appropriate amplification or attenuation according to the estimated presence probabilities.

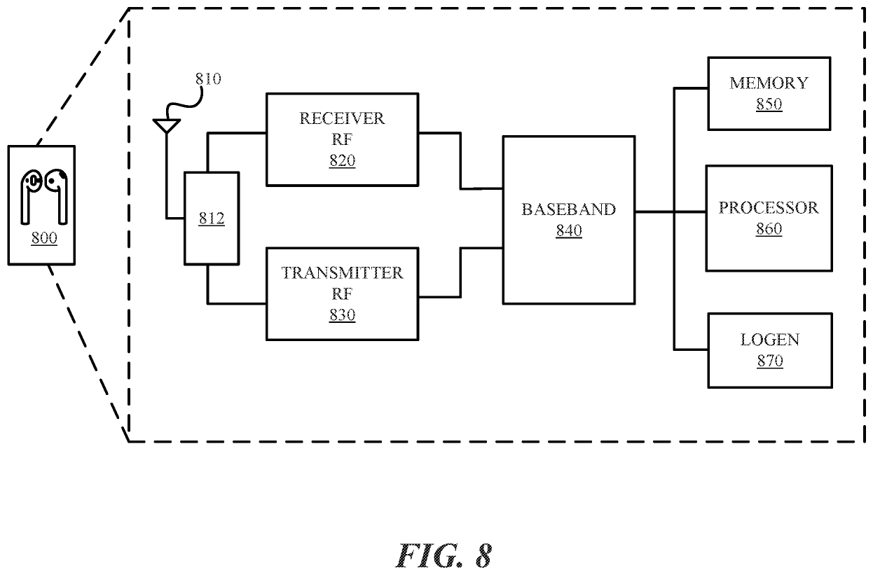

The bin-by-bin OVPP derived from the own voice adjustment circuitry 410 provides valuable information that can be utilized in the own voice processing model to adjust for hearing loss compensation. This enables the user's own voice to be processed differently from ambient sound, resulting in an optimized listening experience. In one or more implementations, the own voice processing model may represent a trained machine learning model, of which aspects will be described with reference to FIG. 8 below.

To determine the OVPP values, the own voice adjustment circuitry 410 analyzes the characteristics of the audio signals in each frequency bin over time. It considers both the user's own voice and ambient sounds present within that bin. By examining the temporal characteristics of the signals, the own voice adjustment circuitry 410 can identify instances of overlap.

In cases where overlap occurs, the own voice adjustment circuitry 410 employs a decision-making process that prioritizes the user's own voice as the dominant signal within the frequency bin. This is based on the understanding that the user's own voice is typically the primary speech signal of interest, while ambient sounds are considered as background noise or interference.

By assigning a higher probability to the user's own voice within overlapping time intervals, the own voice adjustment circuitry 410 indicates its dominance within that frequency bin. This recognition enables subsequent processing stages to treat the user's own voice differently from ambient sounds.

This approach allows for accurate representation and differentiation between the user's own voice and ambient speech. It facilitates that the user's speech is given priority and receives processing tailored to their specific hearing needs, while ambient sounds are attenuated or suppressed to enhance speech intelligibility.

Overall, by considering the dominance of the user's own voice within frequency bins, the own voice adjustment circuitry 410 generates OVPP values that reflect the presence and significance of the user's speech. This information may be used by subsequent processing stages to differentiate and optimize the user's own voice from ambient sounds, providing an improved and customized listening experience.

The own voice processing model takes into account the estimated OVPP values for each frequency bin. It leverages this information to apply customized processing techniques specifically tailored to the user's own voice. By differentiating the user's own voice from ambient sounds, the model can address the unique characteristics and challenges associated with applying hearing loss compensation to the user's speech.

Based on the OVPP values, the own voice processing model can selectively enhance or modify certain aspects of the user's own voice representation. This may involve adjusting the gain, frequency response, dynamic range, or other parameters to compensate for the user's specific hearing loss profile. These modifications aim to optimize the audibility, clarity, and overall perception of the user's own voice.

Simultaneously, the own voice processing model can apply distinct processing techniques to the ambient sound circuitry. By recognizing the absence of the user's own voice in specific frequency bins, the model can focus on suppressing or reducing the amplification of background noise or other non-essential sounds. This selective processing helps enhance the perception of the user's own voice by minimizing the interference from ambient sounds.

The integration of bin-by-bin OVPP values within the own voice processing model allows for personalized and adaptive adjustments in hearing loss compensation. By processing the user's own voice differently from ambient sound, the model optimizes the representation of the user's speech, enhancing audibility and intelligibility. This tailored approach contributes to a more effective and natural listening experience for individuals with hearing loss.

Meanwhile, the output of the own voice adjustment circuitry 410 and the output from the microphone 308 are directed to the hearing loss compensation circuitry 412, which applies specific algorithms to compensate for any hearing impairments the user may have. This circuitry modifies the audio signal to enhance audibility and facilitate optimal perception for individuals with varying degrees of hearing loss. In one or more implementations, the hearing loss compensation circuitry 412 applies a universal gain to account for the user's hearing loss; however, the own voice adjustment circuitry 410 has previously applied or adjusted the gain of the user's own voice, which causes it to be amplified differently by the hearing loss compensation circuitry 412 than the ambient sounds. In one or more implementations, the hearing loss compensation circuitry 412 is implemented at least partially by hardware, firmware, or software. In some implementations, some of the functionalities of the hearing loss compensation circuitry 412 can be performed by a processor of a host device, such as a smartphone or a smartwatch.

The microphone 308 output is combined with the output from the hearing loss compensation circuitry 412 and the noise suppression circuitry 408 in the gain combiner 414. The gain combiner 414 adjusts the volume levels of the different input signals and combines them into a unified output signal.

The final audio signal output from the gain combiner 414 is then routed to the speaker 416, allowing the user to hear their own voice with improved clarity and intelligibility.

In one or more implementations, the gain combiner 414 is implemented at least partially by hardware, firmware, or software. In some implementations, some of the functionalities of the gain combiner 414 can be performed by a processor of a host device, such as a smartphone or a smartwatch. The gain combiner 414 adds the gain-compensation signal of the hearing loss compensation circuitry 412 to the input audio signal from the microphone 308 and provides the final audio signal output to the speaker 416. Because the gain-compensation signal includes separate gains between the user's own voice and ambient sounds, the final audio signal output includes the different gains applied to the own voice and the ambient sound. The final audio signal output includes the noise-free audio from the microphone 308 and the self-voice of the user at a controlled level, based on the level of the ambient noise in the input signal.

In one or more implementations, the user of the electronic device 210 may undergo a hearing profile enrollment process to configure the electronic device 210 to meet any specific needs and preferences of the user. During the hearing profile enrollment, the user may be presented with a fine-tuning slider, which represents a visual control interface. The fine-tuning slider is a user-adjustable feature designed to allow individuals to customize and adjust their preferred voice gain during the hearing profile enrollment process. This feature provides a personalized and flexible approach to meet the specific needs and preferences of the user by allowing the user to adjust a user defined gain setting that is configurable via user input. For example, the fine-tuning slider can allow the user to manually adjust the user's own voice gain level by way of user input via the fine-tuning slider for their own voice, according to their personal preference. The user can move the slider along a continuum, indicating their desired level of amplification for the gain level of their own voice. In one or more other implementations, a user may be presented with another fine-tuning slider that allows the user to manually adjust the ambient sound gain level, according to their personal preference.

As the user adjusts the fine-tuning slider, the hearing profile enrollment system dynamically modifies the gain settings (e.g., for the user's own voice) to reflect the user's preferences. The system captures and stores the user's preferred voice gain as a user defined gain setting as part of their personalized hearing profile. By offering this level of control and customization, the fine-tuning slider empowers individuals to tailor the amplification of their own voice to their specific comfort and communication needs. It facilitates that the hearing device or audio processing system delivers a personalized and optimized listening experience based on the user's preferred voice gain settings. This feature provides a user-friendly interface and enhances user engagement by allowing them to actively participate in the hearing profile enrollment process. By fine-tuning the voice gain according to their own preferences, individuals can achieve a more personalized and satisfactory listening experience.

FIG. 5A illustrates a chart diagram 500 of an example loudness growth function of own voice and ambient sounds for impaired hearing, in accordance with various aspects of the subject technology. The chart diagram 500 shows different loudness compensation between own voice and ambient sounds. The transmission and perception of the user's own voice, as compared to ambient sounds, exhibit distinguishable characteristics both in physical and psychoacoustic terms. In terms of physical attributes, sound pressure levels differ due to the varying transmission distances to the ear.

For instance, during a conversation at a normal level, when the user acts as a listener, the ambient sound (speech) source is approximately 1 meter away, resulting in a sound pressure level (SPL) reaching the user's ear entrance at approximately 60 dB sound pressure level (or dBSPL). On the other hand, when the user takes on the role of a speaker, the own voice is approximately 72 dBSPL at the ear entrance as opposed to the sound pressure level of 60 dBSPL at a distance of approximately 1 meter. In this regard, since the loudness (sone) perceived for the own voice is higher than that of the ambient sounds, which is attributed to the different physical transmission paths traversed by the user's own voice and ambient sounds as described with reference to FIG. 1, the gain compensation needed for own voice would be lesser than what is expected for the gain compensation of ambient sounds.

In terms of psychoacoustic perception, the growth of perceived loudness differs as the sound pressure level increases. For example, own voice and ambient sounds have different loudness growth functions for users with impaired hearing. In one or more implementations, the operation encompasses the utilization of distinct loudness growth functions for both normal and impaired hearing conditions. The loudness growth function characterizes the relationship between perceived loudness and physical sound pressure level. In this context, the loudness unit used is sone, where 2 sone is perceived as twice as loud as 1 sone. Specifically, 1 sone is defined as the loudness of a 1 kHz tone at 40 dBSPL in a free field.

As illustrated in FIG. 5A, the disclosed loudness growth functions exemplify the disparities between own voice and ambient sounds, represented respectively by lines 502 and 504. The lines 502, 504 of FIG. 5A demonstrate an increase in sound pressure level required to achieve double loudness in different scenarios. For users with impaired hearing, both loudness growth functions become steeper but the line 502 representing own voice has a steeper slope than the line 504 representing ambient sounds.

For example, to double the loudness perception, ambient sounds would require a physical sound pressure level approximately 10 dB (around 3 times) higher than the initial level. In contrast, the user's own voice would only need a physical sound pressure level increase of less than 5 dB (less than 2 times) to achieve the same doubling of loudness perception.

The above description highlights the distinctions in the transmission and perception of the user's own voice compared to ambient sounds attributed to the different physical transmission paths traversed by the user's own voice and ambient sounds as described above with reference to FIG. 1, considering both physical sound pressure levels and psychoacoustic loudness growth. These insights can provide considerations for the design and optimization of hearing devices and audio processing algorithms to facilitate optimal perception and comfort for users.

FIG. 5B illustrates a chart diagram 550 of an example loudness compensation of own voice and ambient sounds for impaired hearing, in accordance with various aspects of the subject technology. The disclosed operation pertains to the restoration of loudness to normal levels, whereby the required gain for own voice is determined to be less than that for ambient sounds. This distinction is exemplified in FIG. 5B, which illustrates an example scenario. For example, the chart diagram 550 shows different loudness compensation between own voice and ambient sounds for users with impaired hearing, in which the gain applied to the own voice (represented by line 552) will be lesser than the gain applied to the ambient sounds (represented by line 554).

In one example, the same gain line may be applied to both own voice and ambient sounds. However, this approach leads to the own voice being excessively loud for users, causing discomfort. To address this issue and provide an improved solution, the present disclosure introduces a novel approach. By differentiating the gain lines between own voice and ambient sounds, the restoration of loudness to normal levels can be achieved more accurately. This facilitates that the amplified own voice remains at an appropriate level of audibility, thereby enhancing user comfort and satisfaction.

The described method and system represent an innovative advancement over existing techniques by addressing the problem of excessive loudness when amplifying own voice with the same gain as ambient sounds. Implementing the disclosed approach in hearing devices and audio processing systems enables the restoration of loudness to normal levels while considering the specific gain adjustments required for own voice, thereby improving the overall listening experience for users.

FIG. 6A illustrates a chart diagram 600 of an example of dominant ambient sounds coexisting with own voice sound at frequency bins, in accordance with various aspects of the subject technology. The chart diagram 600 shows sound pressure levels of own voice and ambient sounds at different frequency bins. One aspect of an operation performed by the own voice adjustment circuitry 410 involves estimating a bin-by-bin suppression gain for the speech signal. The bin-by-bin suppression gain estimation is based on analyzing the spectral characteristics of the speech signal in each frequency bin. The own voice adjustment circuitry 410 performs a spectral analysis of the incoming speech signal, dividing it into individual frequency bins as illustrated in FIG. 6A.

The own voice adjustment circuitry 410 can apply noise suppression to the dominant signal by attenuating the dominant signal in a frequency bin of the one or more frequency bins based on a determination that the dominant signal corresponds to the ambient sound. By applying the estimated bin-by-bin suppression gains to the speech signal, the own voice adjustment circuitry 410 selectively reduces the amplitude or power of the noise in each frequency bin that has the dominant signal characterized as the ambient sounds. In one or more implementations, the own voice adjustment circuitry 410 can refrain from attenuating the speech signal in a corresponding frequency bin when the dominant signal is characterized as own voice. For example, for the non-dominant ambient sound signals, the own voice adjustment circuitry 410 can refrain from applying noise suppression to the dominant signal in a frequency bin of the one or more frequency bins based on a determination that the dominant signal corresponds to the voice of the user of the electronic device 210. This process helps enhance the clarity and intelligibility of the speech signal by minimizing the interference caused by background noise.

In one or more implementations, the own voice adjustment circuitry 410 of FIG. 4, for example, can determine a dominant signal between the ambient sound and the voice of the user of the electronic device 210 for one or more frequency bins associated with the received audio signal based on at least partial overlap of the ambient sound with the voice of the user of the electronic device 210 in frequency.

The OVPP value, generated through the own voice adjustment circuitry 410, facilitates determining the dominant signal between the user's own voice and ambient sounds within a given frequency bin. This information is employed by the hearing loss compensation circuitry 412 to accurately differentiate and prioritize the relevant signals. When processing audio signals, the hearing loss compensation circuitry 412 analyzes the OVPP values on a bin-by-bin basis. Each frequency bin is evaluated to assess the likelihood of the user's own voice being present compared to ambient sounds.

Based on the OVPP value for a specific frequency bin, the own voice adjustment circuitry 410 determines the dominant signal. If the OVPP value indicates a higher probability of the user's own voice, the own voice adjustment circuitry 410 recognizes the own voice as the dominant signal within that bin. Conversely, if the OVPP value suggests a lower probability of the user's own voice, the own voice adjustment circuitry 410 identifies ambient sounds as the dominant signal.

By making this distinction, the own voice adjustment circuitry 410 can adapt its processing techniques accordingly. When the user's own voice is identified as the dominant signal, the own voice adjustment circuitry 410 facilitates that the own voice is preserved and appropriately amplified to maintain audibility and intelligibility. In contrast, when ambient sounds are identified as the dominant signal, the own voice adjustment circuitry 410 focuses on suppressing or reducing the amplification of those sounds to enhance speech clarity and reduce background noise interference.

The use of OVPP values enables the own voice adjustment circuitry 410 to dynamically adjust its processing strategy, ensuring that the user's own voice is accurately distinguished and prioritized within the audio signal. This enhances the overall listening experience by managing the presence of ambient sounds while maintaining the integrity of the user's own voice.

For each frequency bin, the own voice adjustment circuitry 410 calculates a suppression gain value. This gain value represents the amount by which the ambient sounds in that particular frequency bin should be attenuated, which is illustrated with reference to FIG. 6B. The gain estimation takes into account the power or magnitude of the ambient sounds in relation to the desired own voice signal. FIG. 6B illustrates a chart diagram 650 of an example loud compensation to frequency bins coexisting with own voice and ambient sounds, in accordance with various aspects of the subject technology. The chart diagram 650 shows the gain applied to own voice and ambient sounds at different frequency bins. For dominant signals corresponding to ambient sounds, the gain of the speech signal containing a dominant unwanted signal (e.g., not the user's own voice) is attenuated (or reduced) in a corresponding frequency bin. For dominant signals corresponding to own voice, the gain of the speech signal containing a dominant wanted signal (e.g., the user's own voice) is maintained (or increased) in a corresponding frequency bin.

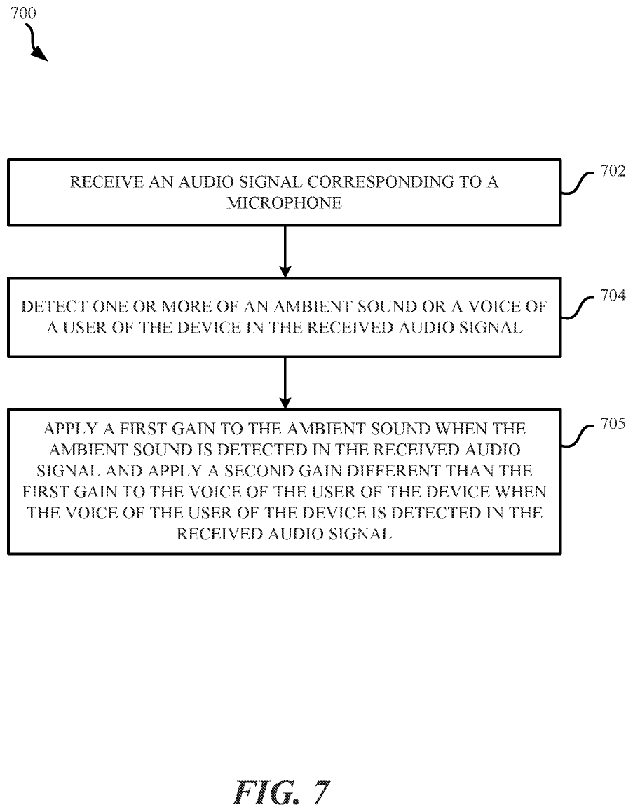

FIG. 7 illustrates a flow diagram of an example process 700 of own voice audio processing, in accordance with various aspects of the subject technology. For explanatory purposes, the process 700 is primarily described herein with reference to the audio processing circuitry 230 of FIG. 2. However, the process 700 is not limited to the audio processing circuitry 230 of FIG. 2, and one or more blocks (or operations) of the process 700 may be performed by one or more other components of other suitable devices, such as earbuds, headphones, headsets, and the like. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At step 702, the device receives an audio signal corresponding to a microphone. For example, the own voice activity detector 406 receives the audio signal from the microphone 308. In another example, the noise suppression circuitry 408 receives the audio signal from the microphone 308. In another example, the hearing loss compensation circuitry 412 receives the audio signal from the microphone 308. In another example, the gain combiner 414 receives the audio signal from the microphone 308.

At step 704, the device detects one or more of an ambient sound or a voice of a user of the device in the received audio signal. For example, the own voice adjustment circuitry 410 detects one or more of an ambient sound or a voice of a user of the electronic device 210 in the received audio signal. In one or more implementations, the one or more of the ambient sound or the voice of the user of the device are detected based at least in part on a classification indicating that the received audio signal contains the voice of the user of the device and does not contain the ambient sound. For example, the own voice adjustment circuitry 410 can detect the one or more of the ambient sound or the voice of the user of the electronic device 210 based at least in part on a classification indicating that the received audio signal contains the voice of the user of the electronic device 210 and does not contain the ambient sound. In one or more other implementations, the one or more of the ambient sound or the voice of the user of the device are detected based at least in part on a classification indicating that the received audio signal contains the ambient sound and does not contain the voice of the user of the device.

For example, the own voice adjustment circuitry 410 can detect the one or more of the ambient sound or the voice of the user of the electronic device 210 based at least in part on a classification indicating that the received audio signal contains the ambient sound and does not contain the voice of the user of the electronic device 210. In one or more other implementations, the one or more of the ambient sound or the voice of the user of the device are detected based at least in part on a classification indicating that the received audio signal contains a combination of the ambient sound and the voice of the user of the device. For example, the own voice adjustment circuitry 410 can detect the one or more of the ambient sound or the voice of the user of the electronic device 210 based at least in part on a classification indicating that the received audio signal contains a combination of the ambient sound and the voice of the user of the electronic device 210. In some implementations, the device detects the voice of the user of the device in the received audio signal based at least in part on one or more measurements from the accelerometer. For example, the own voice activity detector 406 can detect the voice of the user of the electronic device 210 in the received audio signal based at least in part on one or more measurements from the accelerometer 302.

In some implementations, the device can determine an OVPP value for one or more frequency bins associated with the received audio signal, in which the own voice presence probability value indicates a likelihood that the voice of the user of the device is present in a frequency bin of the one or more frequency bins. For example, the own voice adjustment circuitry 410 can determine the OVPP value of the received audio signal for one or more frequency bins.

In one or more implementations, the device can determine a dominant signal between the ambient sound and the voice of the user of the device for one or more frequency bins associated with the received audio signal based on at least partial overlap of the ambient sound with the voice of the user of the device in frequency. For example, the own voice adjustment circuitry 410 can determine whether the ambient sound or own voice is the dominant signal in the received audio signal for a corresponding frequency bin. In one or more implementations, the device can refrain from applying noise suppression to the dominant signal in a frequency bin of the one or more frequency bins based on a determination that the dominant signal corresponds to the voice of the user of the device. For example, the own voice adjustment circuitry 410 can refrain from attenuation (or suppressing) the gain value of the received audio signal within a corresponding frequency bin when the dominant signal in the received audio signal is determined to correspond to own voice. In one or more other implementations, the device can apply noise suppression to the dominant signal by attenuating the dominant signal in a frequency bin of the one or more frequency bins based on a determination that the dominant signal corresponds to the ambient sound. For example, the own voice adjustment circuitry 410 can apply attenuation (or suppression) to the gain value of the received audio signal within a corresponding frequency bin when the dominant signal in the received audio signal is determined to correspond to ambient sounds.

At step 706, the device applies a first gain to the ambient sound when the ambient sound is detected in the received audio signal and applies a second gain different than the first gain to the voice of the user of the device when the voice of the user of the device is detected in the received audio signal. In one or more implementations, the device can adjust the second gain based at least in part on the own voice presence probability value. In one or more implementations, the first gain and the second gain correspond to different psychoacoustic loudness growth functions.

FIG. 8 illustrates a wireless communication device 800 within which some aspects of the subject technology are implemented. In one or more implementations, the wireless communication device 800 can be a headset or an earbud device of the subject technology, for example, any of the electronic device 210 or audio processing circuitry 230 of FIG. 2, 3 or 4. The wireless communication device 800 may include a radio-frequency (RF) antenna 810, a duplexer 812, a receiver 820, a transmitter 830, a baseband processing module 840, a memory 850, a processor 860 and a local oscillator generator (LOGEN) 870. In various aspects of the subject technology, one or more of the blocks represented in FIG. 8 may be integrated on one or more semiconductor substrates. For example, the blocks 820-870 may be realized in a single chip or a single system on a chip, or may be realized in a multichip chipset.

The receiver 820 may include suitable logic circuitry and/or code that may be operable to receive and process signals from the RF antenna 810. The receiver 820 may, for example, be operable to amplify and/or down-convert received wireless signals. In various aspects of the subject technology, the receiver 820 may be operable to cancel noise in received signals and may be linear over a wide range of frequencies. In this manner, the receiver 820 may be suitable for receiving signals in accordance with a variety of wireless standards, such as Wi-Fi, WiMAX, Bluetooth, and various cellular standards. In various aspects of the subject technology, the receiver 820 may not use any sawtooth acoustic wave (SAW) filters and few or no off-chip discrete components such as large capacitors and inductors.

The transmitter 830 may include suitable logic circuitry and/or code that may be operable to process and transmit signals from the RF antenna 810. The transmitter 830 may, for example, be operable to upconvert baseband signals to RF signals and amplify RF signals. In various aspects of the subject technology, the transmitter 830 may be operable to upconvert and amplify baseband signals processed in accordance with a variety of wireless standards. Examples of such standards may include Wi-Fi, WiMAX, Bluetooth, and various cellular standards. In various aspects of the subject technology, the transmitter 830 may be operable to provide signals for further amplification by one or more power amplifiers.

The duplexer 812 may provide isolation in the transmit band to avoid saturation of the receiver 820 or damaging parts of the receiver 820, and to relax one or more design requirements of the receiver 820. Furthermore, the duplexer 812 may attenuate the noise in the receive band. The duplexer 812 may be operable in multiple frequency bands of various wireless standards.

The baseband processing module 840 may include suitable logic, circuitry, interfaces, and/or code that may be operable to perform the processing of baseband signals. The baseband processing module 840 may, for example, analyze received signals and generate control and/or feedback signals for configuring various components of the wireless communication device 800, such as the receiver 820. The baseband processing module 840 may be operable to encode, decode, transcode, modulate, demodulate, encrypt, decrypt, scramble, descramble, and/or otherwise process data in accordance with one or more wireless standards.

The processor 860 may include suitable logic, circuitry, and/or code that may enable processing data and/or controlling operations of the wireless communication device 800. In this regard, the processor 860 may be enabled to provide control signals to various other portions of the wireless communication device 800. The processor 860 may also control transfer of data between various portions of the wireless communication device 800. Additionally, the processor 860 may enable implementation of an operating system or otherwise execute code to manage operations of the wireless communication device 800. In one or more implementations, the processor 860 can be used to perform some of the functionalities of the subject technology.

The memory 850 may include suitable logic, circuitry, and/or code that may enable storage of various types of information such as received data, generated data, code, and/or configuration information. The memory 850 may comprise, for example, RAM, ROM, flash, and/or magnetic storage. In various aspects of the subject technology, information stored in the memory 850 may be utilized for configuring the receiver 820 and/or the baseband processing module 840. In some implementations, the memory 850 may store image information from processed and/or unprocessed fingerprint images of the under-display fingerprint sensor of the subject technology.

The LOGEN 870 may include suitable logic, circuitry, interfaces, and/or code that may be operable to generate one or more oscillating signals of one or more frequencies. The LOGEN 870 may be operable to generate digital and/or analog signals. In this manner, the LOGEN 870 may be operable to generate one or more clock signals and/or sinusoidal signals. Characteristics of the oscillating signals such as the frequency and duty cycle may be determined based on one or more control signals from, for example, the processor 860 and/or the baseband processing module 840.

In operation, the processor 860 may configure the various components of the wireless communication device 800 based on a wireless standard according to which it is desired to receive signals. Wireless signals may be received via the RF antenna 810, amplified, and down converted by the receiver 820. The baseband processing module 840 may perform noise estimation and/or noise cancellation, decoding, and/or demodulation of the baseband signals. In this manner, information in the received signal may be recovered and utilized appropriately. For example, the information may be audio and/or video to be presented to a user of the wireless communication device 800, data to be stored to the memory 850, and/or information affecting and/or enabling operation of the wireless communication device 800. The baseband processing module 840 may modulate, encode, and perform other processing on audio, video, and/or control signals to be transmitted by the transmitter 830 in accordance with various wireless standards.

In one or more implementations, the wireless communication device 800 may provide a system for training a machine learning model using training data, where the trained machine learning model is subsequently deployed to the wireless communication device 800. Further, the wireless communication device 800 may provide one or more machine learning frameworks for training machine learning models and/or developing applications using such machine learning models. In an example, such machine learning frameworks can provide various machine learning algorithms and models for different problem domains in machine learning. In an example, the wireless communication device 800 may include a deployed machine learning model that provides an output of data corresponding to a prediction or some other type of machine learning output. In one or more implementations, training and inference operations that involve individually identifiable information of a user of the wireless communication device 800 may be performed entirely on the wireless communication device 800, to prevent exposure of individually identifiable data to devices and/or systems that are not authorized by the user.

In one or more implementations, the wireless communication device 800 may connect to, or may be communicatively connected to, a server (not shown) that may provide a system for training a machine learning model using training data, where the trained machine learning model is subsequently deployed to the server and/or to the wireless communication device 800. In an implementation, the server may train a given machine learning model for deployment to a client electronic device (e.g., the wireless communication device 800). In one or more implementations, the server may train portions of the machine learning model that are trained using (e.g., anonymized) training data from a population of users, and the wireless communication device 800 may train portions of the machine learning model that are trained using individual training data from the user of the wireless communication device 800. The machine learning model deployed on the server and/or the wireless communication device 800 can then perform one or more machine learning algorithms. In an implementation, the server provides a cloud service that utilizes the trained machine learning model and/or continually learns over time.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Various functions described above can be implemented in digital electronic circuitry, as well as, in computer software, firmware or hardware. The techniques can be implemented by using one or more computer program products. Programmable processors and computers can be included in or packaged as mobile devices. The processes and logic flows can be performed by one or more programmable processors and by one or more programmable logic circuitries. General and special-purpose computing devices and storage devices can be interconnected through communication networks.

Some implementations include electronic components, such as microprocessors and storage and memory that store computer program instructions in a machine-readable or computer-readable medium (alternatively referred to as computer-readable storage media, machine-readable media, or machine-readable storage media). Some examples of such computer-readable media include RAM, ROM or flash memory. The computer-readable media can store a computer program that is executable by at least one processing unit and include sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multicore processors that execute software, some implementations are performed by one or more integrated circuits, such as application-specific integrated circuits (ASICs) or field-programmable gate arrays (FPGAs). In some implementations, such integrated circuits execute instructions that are stored on the circuit itself.

As used in this specification and any claims of this application, the terms “computer”, “processor,” and “memory” all refer to electronic or other technological devices. These terms exclude people or groups of people. For the purposes of the specification, the terms “display” or “displaying” mean displaying on an electronic device. As used in this specification and any claims of this application, the terms “computer-readable medium” and “computer-readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device as described herein for displaying information to the user and a keyboard and a pointing device, such as a mouse, by which the user can provide input to the computer. Other kinds of devices can be used to provide for interaction with a user as well; for example, feedback provided to the user can be any form of sensory feedback, such as visual feedback, auditory feedback, or tactile feedback. Input from the user can be received in any form, including acoustic, speech, or tactile input.

Many of the above-described features and applications are implemented as software processes that are specified as a set of instructions recorded on a computer-readable storage medium (also referred to as a computer-readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as subparts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages and declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Some of the blocks may be performed simultaneously. For example, in certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its), and vice versa. Headings and subheadings, if any, are used for convenience only and do not limit the subject disclosure.

The predicate words “configured to,” “operable to,” and “programmed to” do not imply any particular tangible or intangible modification of a subject, but rather are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects, and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations, and vice versa.

The word “example” is used herein to mean “serving as an example or illustration.” Any aspect or design described herein as an “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for,” or, in the case of a method claim, the element is recited using the phrase “step for.” Furthermore, to the extent that the terms “include,” “have,” or the like are used in the description or the claims, such terms are intended to be inclusive in a manner similar to the term “comprise,” as “comprise” is interpreted when employed as a transitional word in a claim.

What is claimed is:

1. A device comprising:
a microphone; and
a processor configured to:
receive an audio signal corresponding to the microphone;
detect one or more of an ambient sound or a voice of a user of the device in the received audio signal; and
apply a first gain to the ambient sound when the ambient sound is detected in the received audio signal and apply a second gain different than the first gain to the voice of the user of the device when the voice of the user of the device is detected in the received audio signal.

2. The device of claim 1, wherein the one or more of the ambient sound or the voice of the user of the device are detected based at least in part on a classification indicating that the received audio signal contains the voice of the user of the device and does not contain the ambient sound.

3. The device of claim 1, wherein the one or more of the ambient sound or the voice of the user of the device are detected based at least in part on a classification indicating that the received audio signal contains the ambient sound and does not contain the voice of the user of the device.

4. The device of claim 1, wherein the one or more of the ambient sound or the voice of the user of the device are detected based at least in part on a classification indicating that the received audio signal contains a combination of the ambient sound and the voice of the user of the device.

5. The device of claim 1, further comprising an accelerometer, wherein the processor configured to detect the one or more of the ambient sound or the voice of the user of the device is further configured to detect the voice of the user of the device in the received audio signal based at least in part on one or more measurements from the accelerometer.

6. The device of claim 1, wherein the processor configured to detect the one or more of the ambient sound or the voice of the user of the device is further configured to determine an own voice presence probability value for one or more frequency bins associated with the received audio signal, the own voice presence probability value indicating a likelihood that the voice of the user of the device is present in a frequency bin of the one or more frequency bins.

7. The device of claim 6, wherein the processor configured to apply the second gain is further configured to adjust the second gain based at least in part on the own voice presence probability value.

8. The device of claim 1, wherein the processor is further configured to determine a dominant signal between the ambient sound and the voice of the user of the device for one or more frequency bins associated with the received audio signal based on at least partial overlap of the ambient sound with the voice of the user of the device in frequency.

9. The device of claim 8, wherein the processor is further configured to refrain from applying noise suppression to the dominant signal in a frequency bin of the one or more frequency bins based on a determination that the dominant signal corresponds to the voice of the user of the device.

10. The device of claim 8, wherein the processor is further configured to apply noise suppression to the dominant signal by attenuating the dominant signal in a frequency bin of the one or more frequency bins based on a determination that the dominant signal corresponds to the ambient sound.

11. The device of claim 1, wherein the first gain and the second gain correspond to different psychoacoustic loudness growth functions.

12. The device of claim 1, wherein the second gain corresponds to a user defined gain setting that is configurable via user input during a hearing profile enrollment process of the device.

13. A device comprising:
a microphone; and
a filter configured to:
receive an audio signal corresponding to the microphone;
detect an ambient sound and a voice of a user of the device in the received audio signal;
determine a dominant signal between the ambient sound and the voice of the user of the device for one or more frequency bins associated with the received audio signal based on at least partial overlap of the ambient sound with the voice of the user of the device in frequency; and
apply a first gain when the ambient sound is determined to be the dominant signal for the one or more frequency bins and apply a second gain different than the first gain when the voice of the user of the device is determined to be the dominant signal for the one or more frequency bins.

14. The device of claim 13, wherein the one or more of the ambient sound or the voice of the user of the device are detected based at least in part on a classification indicating that the received audio signal contains the voice of the user of the device and does not contain the ambient sound.

15. The device of claim 13, wherein the one or more of the ambient sound or the voice of the user of the device are detected based at least in part on a classification indicating that the received audio signal contains the ambient sound and does not contain the voice of the user of the device.

16. The device of claim 13, wherein the one or more of the ambient sound or the voice of the user of the device are detected based at least in part on a classification indicating that the received audio signal contains a combination of the ambient sound and the voice of the user of the device.

17. The device of claim 13, further comprising an accelerometer, wherein the filter configured to detect the one or more of the ambient sound or the voice of the user of the device is further configured to detect the voice of the user of the device in the received audio signal based at least in part on one or more measurements from the accelerometer.

18. The device of claim 13, wherein the filter configured to detect the one or more of the ambient sound or the voice of the user of the device is further configured to determine an own voice presence probability value for one or more frequency bins associated with the received audio signal, the own voice presence probability value indicating a likelihood that the voice of the user of the device is present in a frequency bin of the one or more frequency bins, wherein the filter configured to apply the second gain is further configured to adjust the second gain based at least in part on the own voice presence probability value.

19. The device of claim 13, wherein the filter is further configured to:
refrain from applying noise suppression to the dominant signal in a frequency bin of the one or more frequency bins when the dominant signal corresponds to the voice of the user of the device; and
apply noise suppression to the dominant signal by attenuating the dominant signal in a frequency bin of the one or more frequency bins when the dominant signal corresponds to the ambient sound.

20. A method, comprising:
receiving an audio signal corresponding to a microphone;
detecting one or more of an ambient sound or a voice of a user of a device in the received audio signal; and
applying a first gain when the ambient sound is detected in the received audio signal and apply a second gain different than the first gain when the voice of the user of the device is detected in the received audio signal.
